(19) United States
(12) Patent Application Publication
(10) Pub. No.: US 2003/0142962 A1
(43) Pub. Date: Jul. 31, 2003

(54) Information storage medium, information recording apparatus and information reproduction apparatus

(75) Inventors: Yasufumi Tsumagari, Yokohama-shi (JP); Shinichi Kikuchi, Kawasaki-shi (JP); Kazuhiko Taira, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/353,945

(22) Filed: Jan. 30, 2003

(30) Foreign Application Priority Data
Jan. 31, 2002 (JP) 2002-024760

(51) Int. Cl. H04N 5/781

(52) U.S. Cl. 386/95; 386/125

(57) ABSTRACT

An information storage medium according to an embodiment of this invention has a management area for recording management information, and a data area for recording program contents data. The program contents data recorded in the data area contains a plurality of object data, each object data contains a plurality of data units, each data unit contains a plurality of packets, and the management information recorded in the management area contains program stream information of the program contents data.

### CROSS-REFERENCE TO RELATED APPLICATIONS

This application is based upon and claims the benefit of priority from the prior Japanese Patent Application No. 2002-024760, filed Jan. 31, 2002, the entire contents of which are incorporated herein by reference.

### BACKGROUND OF THE INVENTION

1. Field of the Invention

The present invention relates to an information storage medium which stores digitally broadcasted video and audio signals. The present invention also relates to an information recording apparatus for recording, on an information storage medium, video and audio signals and the like distributed by digital broadcasting. Furthermore, the present invention relates to an information reproduction apparatus for reproducing video and audio signals and the like from an information storage medium.

2. Description of the Related Art

In recent years, various standards for DVD (Digital Versatile Disk) have been proposed. As one of such standards, the video recording/reproduction standard of video information is known. This video recording/reproduction standard records packets (AP_PKT) with a given length in a single file (SR_TRANS.SRO) together with their time information (ATS), creates management information (SR_MANGR.IFO) together with this file, and reproduces video information on the basis of this management information.

However, with this standard, program stream information (service information) which is transferred as packets is directly recorded as packets.

For example, when this service information is used as a menu for reproduction, the recorded stream must be searched from the beginning until the service information is found. For this reason, a menu cannot be quickly displayed. Upon reproducing the recorded stream, neither video nor audio can be output until some service information is acquired.

### BRIEF SUMMARY OF THE INVENTION

It is an object of the present invention to provide an information storage medium that conveniently stores service information. It is another object of the present invention to provide an information recording apparatus which conveniently records service information. It is still another object of the present invention to provide an information reproduction apparatus that reproduces the conveniently recorded service information.

In order to solve the aforementioned problems and to achieve the above objects, an information storage medium for storing service information, an information recording apparatus, and an information reproduction apparatus according to the present invention have the following arrangements.

(1) An information storage medium according to an embodiment of the present invention comprises a management area that records management information, and a data area that records program contents data, the program contents data recorded in the data area includes a plurality of object data, where each object data includes a plurality of data units and each data unit includes a plurality of packets, and the management information recorded in the management area includes program stream information of the program contents data.

(2) An information recording apparatus according to an embodiment of the present invention is directed to an information recording apparatus for recording information on an information storage medium including a management area and data area, comprising a first recording unit configured to record management information in the management area, and a recording unit configured to record program contents data in the data area,

the program contents data recorded in the data area including a plurality of object data, each object data including a plurality of data units and each data unit including a plurality of packets, and the management information recorded in the management area including program stream information of the program contents data.

(3) An information reproduction apparatus according to an embodiment of the present invention is directed to an information reproduction apparatus for reproducing information from an information storage medium including a management area and data area, comprising a first reproduction unit configured to reproduce management information from the management area, and a second reproduction unit configured to reproduce program contents data from the data area, the program contents data recorded in the data area including a plurality of object data, each object data including a plurality of data units and each data unit including a plurality of packets, and the management information recorded in the management area including program stream information of the program contents data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing an example of the arrangement of a system for recording/reproducing packet data;

FIG. 2 is a schematic block diagram showing an example of the arrangement of a recording/reproduction apparatus for recording/reproducing packet data;

FIG. 3 shows an example of the data structure upon recording packets according to the DVD-SR standard;

FIG. 4 shows an example of the MPEG-TS packet structure;

FIG. 5 shows an example of the structure of management information of an information storage medium;

FIG. 6 shows an example of the structure of SOB information in the management information of an information storage medium;

FIG. 7 shows an example of the structure of an application private data manager in the management information of an information storage medium;

FIG. 8 shows an example of the structure of a PAT;

FIG. 9 shows an example of the structure of a PMT;

FIG. 10 shows an example of the structure of an SIT;

FIG. 11 shows an example of the descriptor structure of the SIT;

FIG. 12 shows an example of the descriptor structure of the SIT;

FIG. 13 shows an example in which two PATs, two PMTs, and two SITs are recorded in one APDT Area (APDTA);

FIG. 14 shows a storage example of SI except for a real-time information part;

FIG. 15 is a flowchart showing an example of the flow upon recording SI;

FIG. 16 shows an example of normal reproduction;

FIG. 17 shows an example of reproduction when the PATs/PMTs of the management information are inserted;

FIG. 18 is a flowchart showing an example of reproduction of SI;

FIG. 19 shows an example of the transfer times of management information and object data;

FIG. 20 shows an example of the structure of SOB Stream Information;

FIG. 21 shows an example of the data structure of V_ATR data;

FIG. 22 shows an example of the data structure of A_ATR data;

FIG. 23 shows an example of the configuration of a reproduction menu using an SIT;

FIG. 24 shows an example of the configuration of a program information menu using the SIT;

FIG. 25 shows an example of the configuration of a video/audio information menu using the SIT;

FIG. 26 is a flowchart showing an example of the flow upon generating a video attribute;

FIG. 27 is a flowchart showing an example of the flow upon generating an audio attribute;

FIG. 28 is a flowchart showing an example of the flow upon displaying a menu;

FIG. 29 is a flowchart showing an example of the flow upon recording SI;

FIG. 30 shows an example of the structure of original PGC information (ORG_PGCI) in the management information of the information storage medium; and

FIG. 31 is a flowchart showing an example of the flow upon generating PRM_TXTI.

### DETAILED DESCRIPTION OF THE INVENTION

An embodiment of the present invention will be described below with reference to the accompanying drawings.

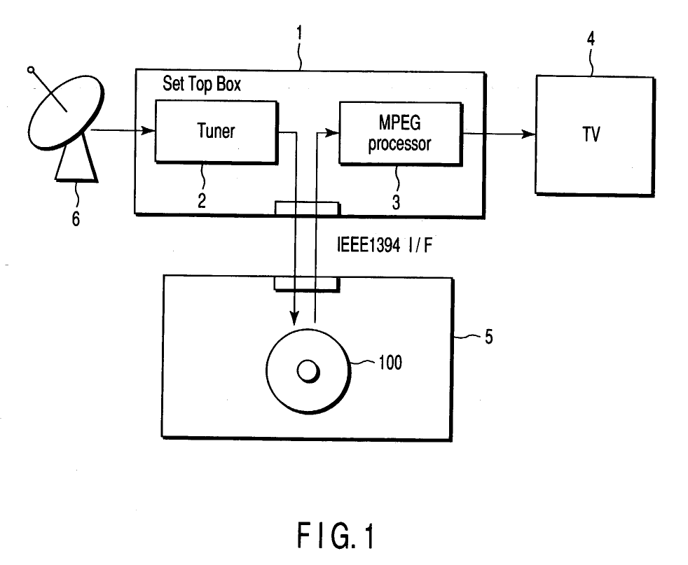

FIG. 1 shows an example of a schematic arrangement of a system for recording/reproducing packet data.

Packet data (188-byte data in the case of, e.g., MPEG-TS: MPEG Transport Stream) distributed by a satellite digital broadcast is received by a tuner 2 of a Set Top Box (STB) 1 via a receiver 6. The received packet data is sent to a recording/reproduction apparatus 5 via a digital interface such as an IEEE1394 interface or the like. The recording/reproduction apparatus 5 assigns time information (APAT: Application Arrival Time) to each packet of the received packet data, and records the packet data on an information storage medium 100 together with the time information. A MAIN MPU 510 of the recording/reproduction apparatus 5 generates management information on the basis of the recorded information, and records it on the information storage medium 100.

As for reproduction, the recording/reproduction apparatus 5 reads out the time information and packet data from the information storage medium 100 on the basis of the management information on the information storage medium 100, and transfers the packet data to the STB 1 via the digital interface in accordance with the time information (APAT). When the STB 1 outputs data to an analog TV 4, an MPEG processor 3 MPEG-decodes the packet data to convert the data into an analog signal, and outputs the analog signal. When the STB 1 outputs data to a digital TV 4, it directly transfers the packet data, and the digital TV 4 executes MPEG decoding.

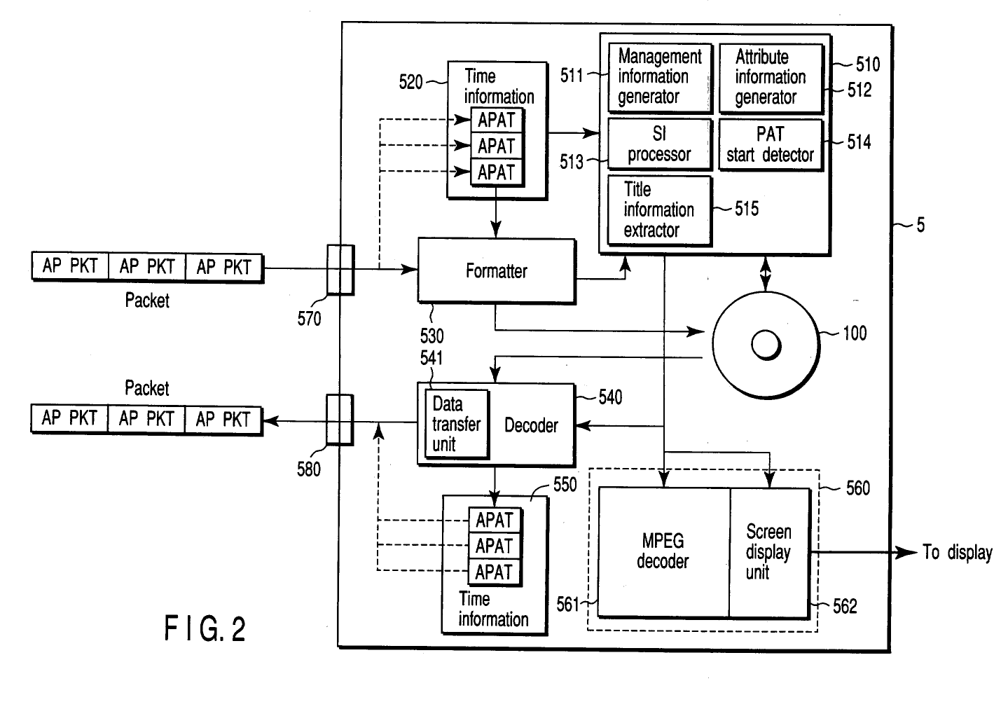

FIG. 2 shows an example of a schematic arrangement of the recording/reproduction apparatus for recording/reproducing packet data.

The recording/reproduction apparatus 5 comprises the MAIN MPU 510, a time measurement unit 520, a formatter 530, a decoder 540, a time information measurement unit 550, a recording/reproduction unit 560, a data input unit 570, and a data output unit 580.

The MAIN MPU 510 comprises a management information generator 511, attribute information generator 512, ST processor 513, PAT start detector 514, and title information extractor 515. The decoder 540 comprises a data transfer unit 541.

The data input unit 570 receives packet data sent from the STB 1. The time measurement unit 520 assigns arrival time information (APAT) to the received packet data. The formatter 530 converts the received packet data and time information into a format (object data) that can be applied to the information storage medium. The management information generator 511 generates management information based on the received packet data and time information. The SI processor 513 extracts service information (SI) from the packet data. The attribute information generator 512 generates video/audio attribute information from the extracted SI. The title information extractor 515 further extracts title information from the extracted SI. The PAT start detector 514 detects whether a packet corresponding to the designated time information is a PAT. The recording/reproduction unit 560 records or reproduces object data and management information on or from an information storage medium such as DVD-RAM/DVD-RW/DVD-R. The decoder 540 extracts packet data to be transferred from the object data using the management information. The data transfer unit 541 transfers the packet data on the basis of the time information. The data output unit 580 transmits the packet data to the STB 1.

In the case of a recording/reproduction apparatus 5 which also has a function of the STB 1 (MPEG processor), a recording/reproduction unit 560 comprises an MPEG decoder 561 and screen display unit 562.

Upon recording the aforementioned packets on an information storage medium such as DVD-RAM/DVD-RW/DVD-R, the DVD Stream Recording (DVD-SR) standard that has been discussed in the DVD Forum can be applied.

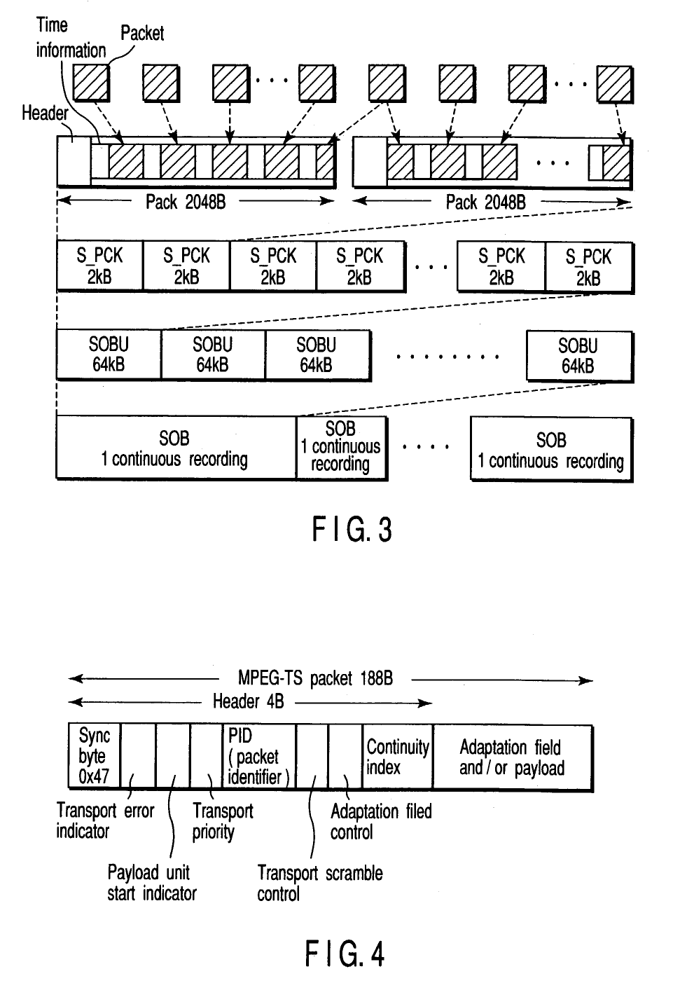

FIG. 3 shows an example of the data structure upon recording packets based on the DVD-SR standard. In the DVD-SR standard, a received packet (188 bytes in case of MPEG-TS) and its time information (4 bytes) are alternately recorded to form a pack (2048 bytes) complying with MPEG Program Stream. Thirty-two 2048-byte MPEG-PS packs (i.e., 64 kB) form an edit unit (SOBU). An SOB which represents one program is formed of one or more SOBUs, and DVD-SR object data is formed of one or more SOBs. On the information storage medium, this object data, and management information that contains information on the reproduction order of the object data and the like are recorded.

FIG. 4 shows an example of the MPEG-TS packet structure. As specified by ISO/IEC 13818-1, a 188-byte MPEG-TS packet consists of a 4-byte header, and a payload, an adaptation field, or an adaptation field and payload, which correspond to the remaining 184 bytes. The payload contains video data, audio data, data broadcast data, and the like, and the adaptation field contains a PCR indicating the reference clock of a program and the like. The packet header consists of an 8-bit sync byte field, 1-bit transport error indicator, 1-bit payload unit start indicator, 1-bit transport priority, 13-bit packet identifier (PID), 2-bit transport scramble control, 2-bit adaptation field control, and 4-bit continuity index.

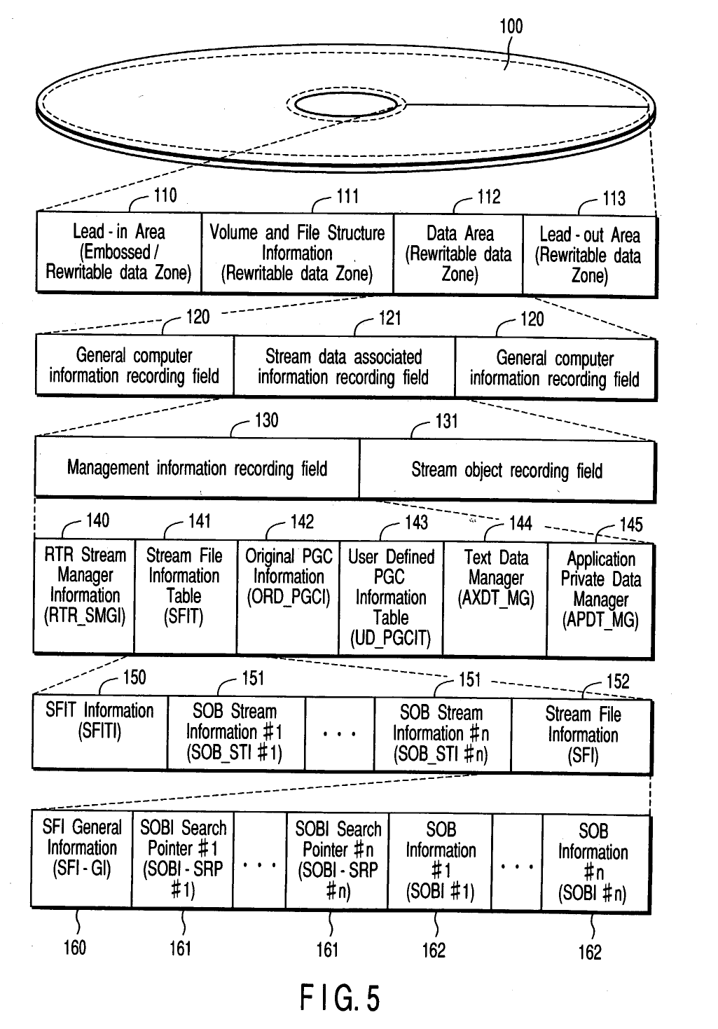

FIG. 5 shows an example of the structure of the management information of the information storage medium.

In the rewritable, disk-shaped information storage medium 100, a data area 112 as an area where the user can record information has a format that allows the presence of both general computer information recording fields and a stream data related information recording field 121. Recordable packet data is called an object, which is recorded in a Stream Object recording field 131, and information associated with that object is recorded in a management information recording field 130.

The management information recording field 130 consists of RTR stream manager information (RTR_SMGI) 140 that records management information of the recorded object, a stream file information table (SFIT) 141 that records attribute information and time information of the recorded object, original PGC information (ORG_PTC) 142 that records reproduction information, a user defined PGC information table (UD_PGCIT) 143 that records play list information, a text data manager (TXDT_MG) 144 that records text information, and an application private data manager (APDT_MG) 145 that records service information.

The stream file information table (SFIT) 141 is formed of SFIT information (SFITI) 150 that records general information in the stream file information table (SFIT) 141, a plurality of pieces of SOB stream information (SOB_STI) 151 each of which records attribute information of the recorded object, and stream file information (SFI) 152 that records time information of the recorded object.

Furthermore, the stream file information (SFI) 152 is made up of SFI general information (SFI_GI) 160 that records general information in the stream file information (SFI) 152, SOBI search pointers (SOBI_SRP) 161 each indicating the storage location of SOB information (SOBI) 162, and a plurality of pieces of SOB information (SOBI) 162 each of which records time information of the recorded object.

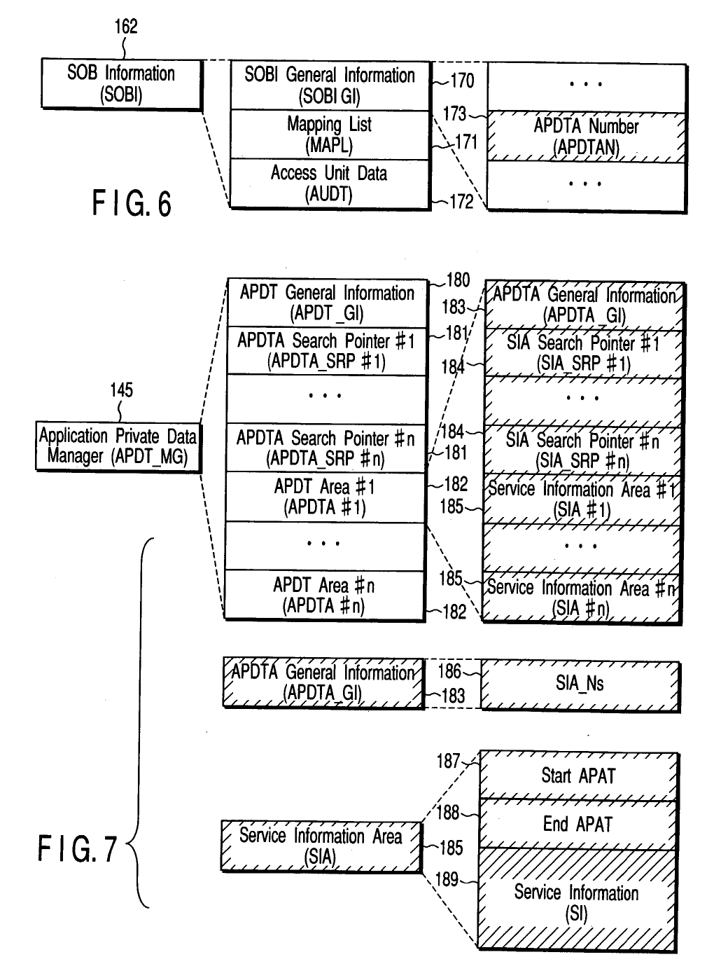

FIG. 6 shows an example of the structure of the SOB information in the management information of the information storage medium.

The SOB information (SOBI) 162 consists of SOBI general information (SOBI_GI) 170 that records general information in the SOB information (SOBI) 162, a mapping list (MAPL) 171 that records time information, and access unit data (AUDT) 172 that records access information.

The SOBI general information (SOBI_GI) 170 is made up of SOB_REC_TM that indicates the recorded time, SOB_STIN that indicates attribute information of an object to be referred to, AUDT_FLAGS that indicates the presence/absence of access information of I-picture and the like, SOB_S_APAT that indicates the reproduction (transfer) start time, SOB_E_APAT that indicates the reproduction (transfer) start time, SOB_S_SOBU indicating the start position of an object, MAPL_ENT_Ns that indicates the size of time information, and an APDTA number (APDTAN) 173 that indicates service information to be referred to.

Especially, the APDTA number (APDTAN) 173 indicates one to be referred to of service information APDT areas (APDTA) 182 recorded in the application private data manager (APDT_MG) 145 using a number.

FIG. 7 shows an example of the structure of the application private data manager in the management information of the information storage medium.

The application private data manager (APDT_MG) 145 includes APDT general information (APDT_GI) 180 that records general information in the application private data manager (APDT_MG) 145, APDTA search pointers (APDTA_SRP) 181 each indicating the storage location of an APDT area (APDTA) 182, and APDT areas (APDTA) 182 each of which records service information of each program.

Each APDT area (APDTA) 182 consists of APDTA general information (APDTA_GI) 183 that records general information of that APDT area (APDTA) 182, SIA search pointers (SIA_SRP) 184 each indicating the storage location of a service information area (SIA) 185, and service information areas (SIA) 185 each of which records service information. Especially, the APDTA general information (APDTA_GI) 183 consists of SIA_Ns 186 indicating the number of recorded service information areas (SIA) 185.

Furthermore, each service information area (SIA) 185 is made up of a start APAT 187 indicating the start position of a period in which the recorded service information is effective, an end APAT 188 indicating the end position of a period in which the recorded service information is effective, and service information 189 as program stream information. Note that each of the aforementioned start and end positions can be expressed by the arrival time (APAT) of each packet or a logical address from the head of object data where each packet is located. In this embodiment, the packet arrival time is used.

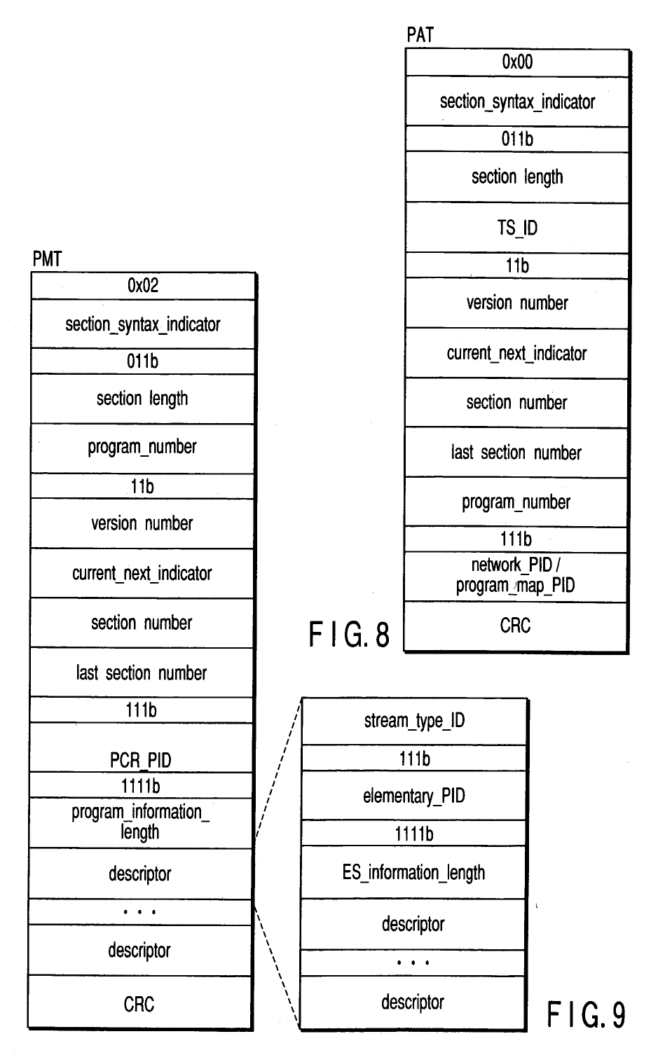

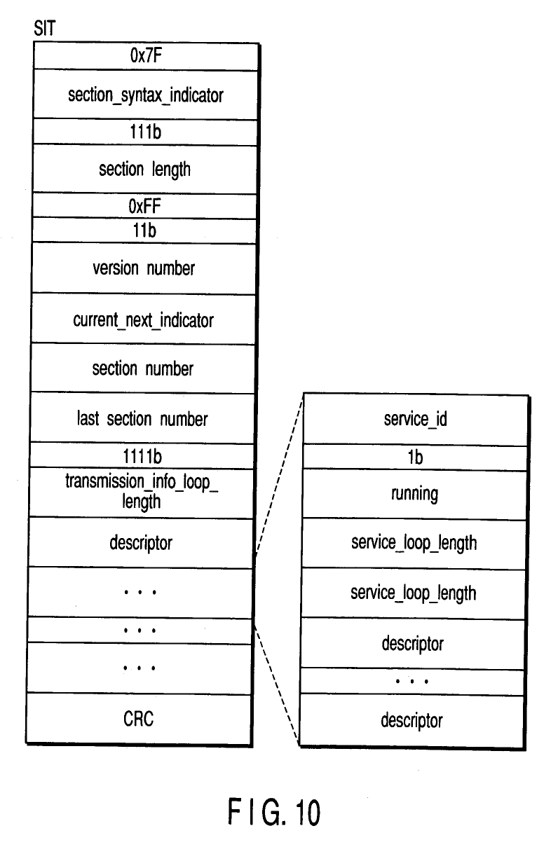

FIG. 8 shows an example of the structure of a PAT, FIG. 9 shows an example of the structure of a PMT, and FIG. 10 shows an example of the structure of an SIT.

As specified by ISO/IEC 13818-1, a PAT (program association table) describes a PID (packet identifier) of a PMT (program map table) and the like, and the PMT describes video, audio, additional data, and PCR PIDs contained in a corresponding program. An MPEG decoder such as an STB or the like reads the PAT to acquire the PID of the PMT, and then reads the PMT based on the acquired PID. Furthermore, the decoder extracts packets which form a target program from a stream with reference to the PIDs described in the PMT. In this way, the PAT and PMT must be read to reproduce an MPEG-TS stream.

On the other hand, an SIT (selection information table) describes an abstract of SI (service information) required to interpret information of a partial transport stream.

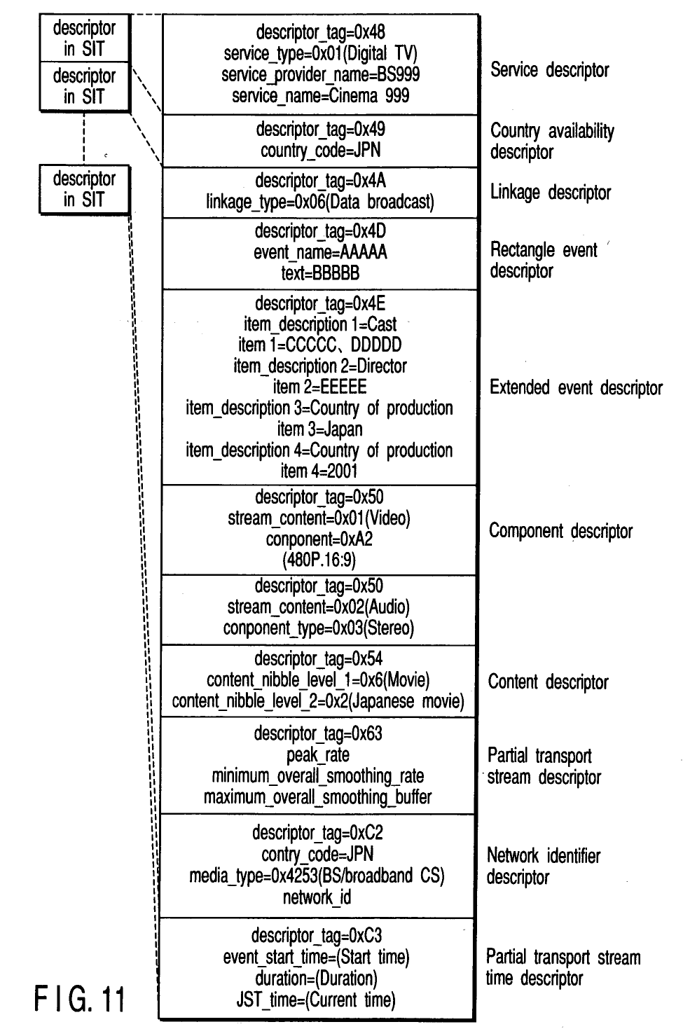

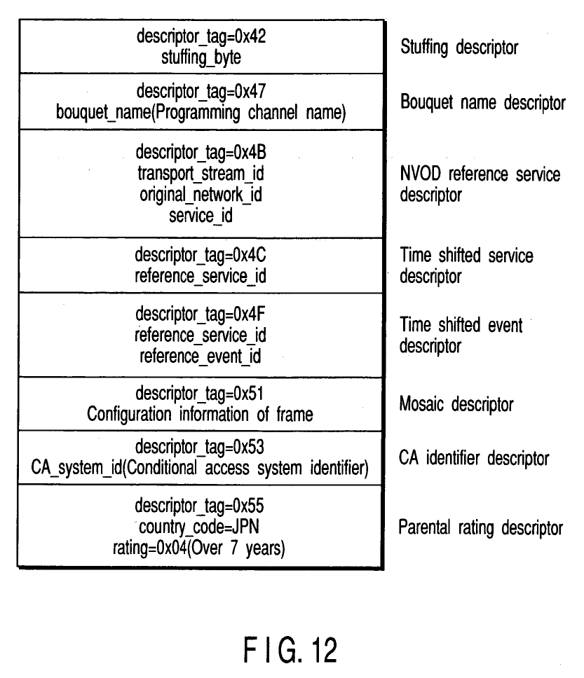

FIGS. 11 and 12 show an example of the descriptor structure of the SIT.

As specified by ETS 300 468 and ARIB STD-B21, the SIT consists of descriptors such as a service descriptor (descriptor_tag=0x48) that describes a programming channel and provider name, a country availability descriptor (descriptor_tag=0x49) that indicates if a service can be received, a linkage descriptor (descriptor_tag=0x4A) that identifies a service to be provided when the viewer requests additional information associated with specific one described in the SI system, a rectangle event descriptor (descriptor_tag=0x4D) that describes an event name and its description, an extended event descriptor (descriptor_tag=0x4E) that provides a detailed description of an event, a component descriptor (descriptor_tag=0x50) that indicates the type of component, a content descriptor (descriptor_tag=0x54) that indicates the genre of an event, a partial transport stream descriptor (descriptor_tag=0x63) as information required to record a partial transport stream, a network identifier descriptor (descriptor_tag=0xC2) used to identify a source network that generated the partial transport stream, a partial transport stream time descriptor (descriptor_tag=0xC3) that describes time information of an event, and that upon output, a stuffing descriptor (descriptor_tag=0x42) used to insert a dummy descriptor for stuffing, a bouquet name descriptor (descriptor_tag=0x47) that indicates a bouquet name, an NVOD reference service descriptor (descriptor_tag=0x4B) that provides a plurality of services which transport events with identical sequences except for the broadcast start times, a time shifted service descriptor (descriptor_tag=0x4C) that provides a service as a time-shifted copy of another service, a time shifted event descriptor (descriptor_tag=0x4F) that indicates an event as a time-shifted copy of another event, a mosaic descriptor (descriptor_tag=0x51) that indicates programming information when a plurality of different videos are used, a CA identifier descriptor (descriptor_tag=0x53) indicating the type of conditional access system, a parental rating descriptor (descriptor_tag=0x55) indicating the parental ratings based on ages, and the like. Especially, the partial transport stream descriptor (descriptor_tag=0x63) and network identifier descriptor (descriptor_tag=0xC2) are required to be stored in the SIT.

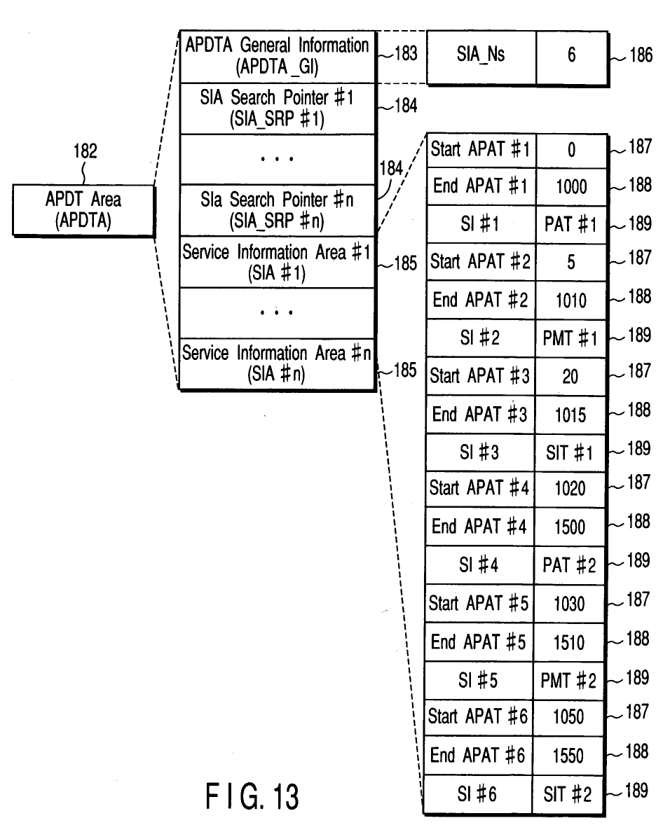

FIG. 13 shows an example wherein two PATs, two PMTs, and two SITs are recorded in one APDT area (APDTA) 182 (designated by one or more SOBs).

The APDTA 182 consists of a total of six service information areas (SIA) 185, each of which records PAT#1, PMT#1, SIT#1, PAT#2, PMT#2, and SIT#2. At this time, the SIA_Ns 186 is set to be 6. The start APAT 187 and end APAT 188 indicate the effective period of that SIA 185. That is, service information described in the SIA 185 is commonly used between the start APAT 187 and end APAT 188. For example, PMT#1 is effective within the APAT range from 5 to 1010.

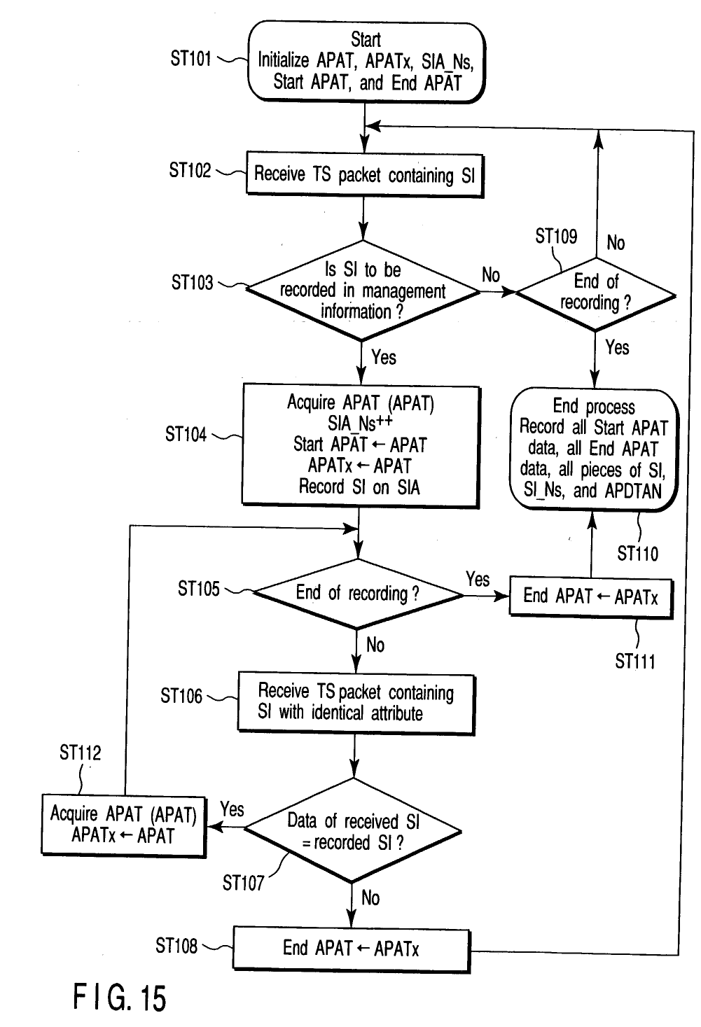

FIG. 15 shows an example of the flow upon recording SI.

The APAT, APATx, SIA_Ns, start APAT, and end APAT are initialized (ST101), a recorder/player receives an MPEG-TS packet stream from the data input unit (ST102), and the formatter converts the received packet stream into object data (stream object), which is recorded on the information storage medium. In this case, the SI processor of the MAIN MPU checks if SI data such as a PAT, PMT, SIT, and the like in each MPEG-TS packet are to be recorded as management information (ST103).

The SI processor extracts a PAT (0x00), PMT, SIT (0x1F) based on the PID of the received MPEG-TS packet (the PID of the PMT can be detected from the PAT). If one of these SI data is to be recorded, the value of the STA_Ns 186 in the APDT area (APDTA) 182 is incremented by one to assure a new service information area (SIA) 185 (ST104). For example, if a PAT is to be recorded (ST105, NO), the PAT is extracted from the MPEG-TS packet, and the time measurement unit acquires the APAT of the MPEG-TS packet that contains the head of the PAT (ST106). At this time, the acquired APAT is recorded as a start APAT 187, and the PAT itself is recorded as service information (SI) 189. The next extracted PAT is compared with the recorded PAT (ST107). If the next extracted PAT is the same as the recorded PAT, it is not recorded (ST112). If the next extracted PAT is different from the recorded PAT (i.e., it is a new one), the APAT, which is acquired in advance by the time measurement unit, of the MPEG-TS packet that contains the head of the PAT immediately before the PAT of interest is recorded as an end APAT 188 (ST108), and recording of the previous PAT is complete. For a new PAT, a new service information area (IA) 185 is assured, and the PAT is recorded in the same manner as described above. Also, the PMT and SIT are recorded by the same method as that described above. In this case, the PAT, PMT, and SIT can be independently and parallelly recorded.

Finally, upon completion of recording of the object data, an APDT area (APDTA) 182 (start APAT 187, end APAT 188, and service information (SI) 189) is recorded in the management information, and the number of the recorded APDTA is recorded in the APDTA number (APDTAN) 173 in the SOB information (SOBI) 162 as attribute information of the object data.

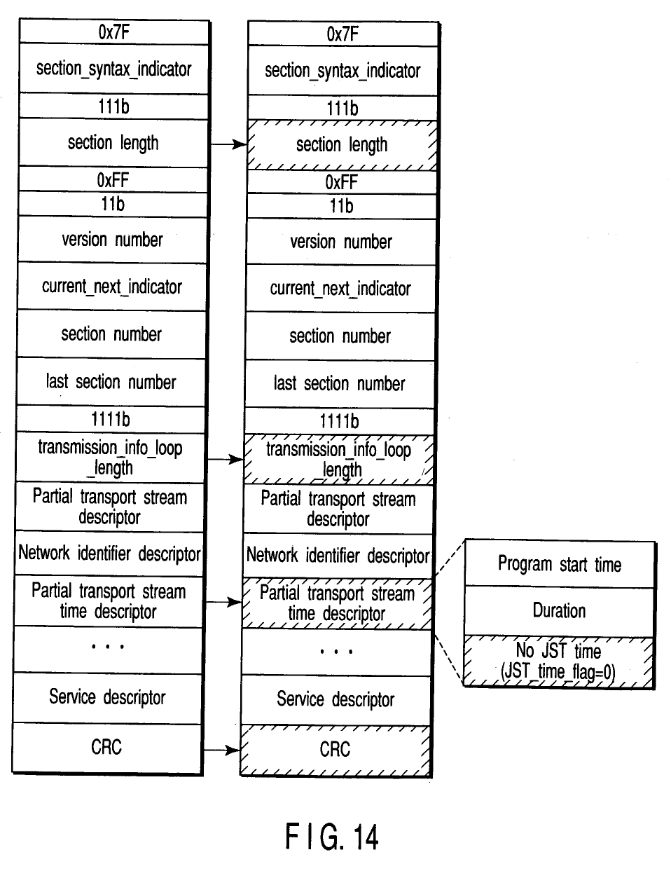

If the SIT contains time-varying information, i.e., information that depends on the real time of broadcast (e.g., a partial transport stream time descriptor (descriptor_tag=0xC3) or the like), the effective period of its SIA 185 becomes very short. For this reason, the SIT is recorded after a real-time information part in a descriptor that contains target real-time information is excluded. In this manner, the effective period of this SIA 185 can be prolonged. For example, the partial transport stream time descriptor contains program start information, continuing time information, JST time (current time information), and the like. At this time, the JST time (current time information) is not recorded, and JST_time_flag=0 indicating that no JST time is contained is set. The partial transport stream time descriptor, which is regenerated in this way, is recorded as the SIT in the SI 189. At this time, the values of information such as section length, transmission_info_loop_length, CRC, and the like must be changed in correspondence with the changed SIT (FIG. 14).

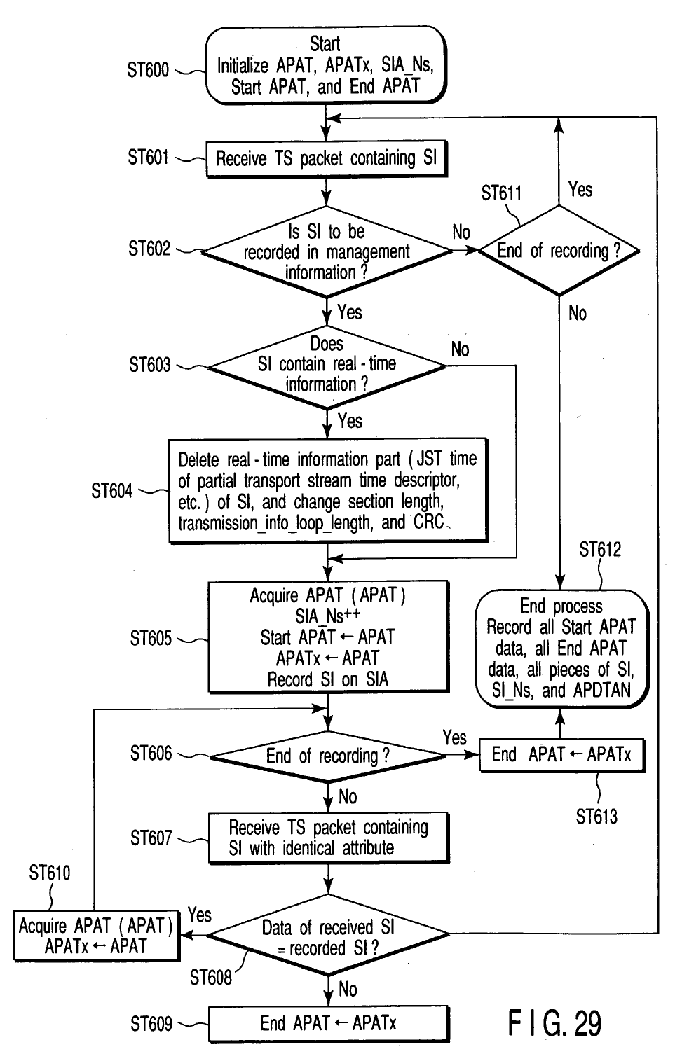

FIG. 29 shows an example of the flow upon recording SI.

The APAT, APATx, SIA_Ns, start APAT, and end APAT are initialized (ST600), a recorder/player receives an MPEG-TS packet stream from the data input unit (ST601), and the formatter converts the received packet stream into object data (stream object), which is recorded on the information storage medium. In this case, the SI processor of the MAIN MPU checks if SI data such as a PAT, PMT, SIT, and the like in each MPEG-TS packet are to be recorded as management information (ST602).

The SI processor extracts a PAT (0x00), PMT, SIT (0x1F) based on the PID of the received MPEG-TS packet (the PID of the PMT can be detected from the PAT). If one of these SI data is to be recorded, it is checked whether that SI contains information (e.g., the JST time of the partial transport time descriptor (descriptor_tag=0xC3) or the like), which is known in advance and changes depending on the time (ST603). If such information is contained, recording is done after that information is excluded (in case of the JST time of the partial transport time descriptor, JST_time_flag=0 is set). Accordingly, the values of information such as section length, transmission_info_loop_length, CRC, and the like are changed (ST604). This SI is to be recorded.

The value of the STA_Ns 186 in the APDT area (APDTA) 182 is incremented by one to assure a new service information area (SIA) 185 (ST605). For example, if a PAT is to be recorded (ST606, NO), the PAT is extracted from the MPEG-TS packet, and the time measurement unit acquires the APAT of the MPEG-TS packet that contains the head of the PAT (ST607). At this time, the acquired APAT is recorded as a start APAT 187, and the PAT itself is recorded as service information (SI) 189. The next extracted PAT is compared with the recorded PAT (ST608). If the next extracted PAT is the same as the recorded PAT, it is not recorded (ST610). If the next extracted PAT is different from the recorded PAT (i.e., it is a new one), the APAT, which is acquired in advance by the time measurement unit, of the MPEG-TS packet that contains the head of the PAT immediately before the PAT of interest is recorded as an end APAT 188 (ST609), and recording of the previous PAT is complete. For a new PAT, a new service information area (IA) 185 is assured, and the PAT is recorded in the same manner as described above.

Finally, upon completion of recording of the object data, an APDT area (APDTA) 182 (start APAT 187, end APAT 188, and service information (SI) 189) is recorded in the management information, and the number of the recorded APDTA is recorded in the APDTA number (APDTAN) 173 in the SOB information (SOBI) 162 as attribute information of the object data.

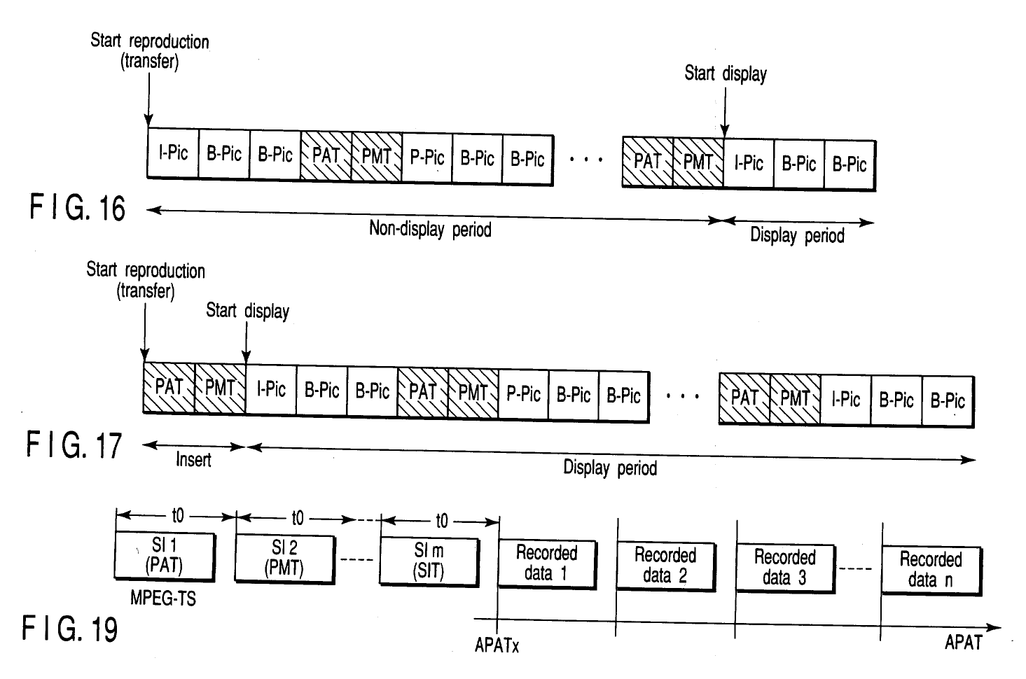

A case will be examined below wherein video data which is compressed by MPEG2 and is recorded as object data (stream object) on the information storage medium is to be reproduced (transferred). For example, FIG. 16 shows a case wherein the recorded object data does not start from a PAT or PMT, or the recorded object data starts from a PAT or PMT, but the reproduction (transfer) start position does not indicate a PAT or PMT. Since the MPEG decoder of the STB acquires the PID of an MPEG-TS packet to be decoded from the PAT and PMT and starts decoding to have an I-picture as a start point if video data is compressed by MPEG2, the actual display start position is an I-picture after the PAT and PMT. Hence, a time lag is generated between the reproduction start position and display start position.

FIG. 17 shows an example of a reproduction method when the PATs/PMTs of the management information are inserted. Even when the reproduction start position does not start from a PAT or PMT, the STB can detect the PID of a packet to be decoded by transferring the PAT and PMT as an MPEG-TS packet in advance. Hence, the decoder of the STB can start display from the position where the first I-picture appears since the reproduction start position.

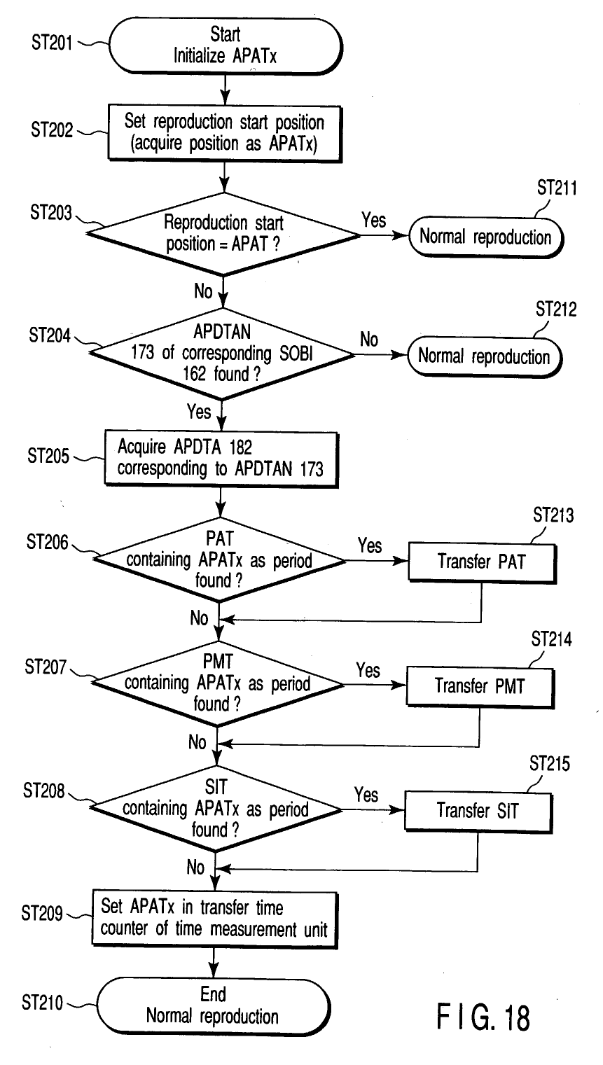

FIG. 18 shows an example of the sequence for transferring SI, which is recorded in the management information in advance, as needed.

Assume that reproduction starts from time APATx in an object SOB#n 131 in accordance with a request from the user or apparatus. The APATx is initialized (ST201), the object SOB#n 131 is searched for an MPEG-TS packet corresponding to the time APATx (ST202), and it is checked whether that packet is a PAT (PID=0x00). If the packet is a PAT (ST203, YES), reproduction is normally executed (ST211). If the found MPEG-TS packet is not a PAT (ST203, NO), PAT information is read out from the management information and is transferred.

The APDTAN 173 of SOBI_GI 170 in SOBI#n 162 corresponding to the SOB#n 131 is acquired (ST204, YES). If the APNTAN 173 does not record the number of any APDTA 182 that records SI information to be referred to, normal reproduction starts immediately (ST212). Assume that the APDTA 182 records “m”.

SIAs 185 recorded in an APDTA#m 182 of the APDT_MG 145 are searched for (ST205). SI data 189 which have the start APATs 187 and end APATs 188 which satisfy:

Start APAT≦APATx≦End APAT

in the APDTA#m 182 are extracted (ST206, ST207, ST208). These SI data are transferred as an MPEG-TS packet to the decoder of the STB. At this time, since the PID of the PMT (table ID=0x02) is obtained with reference to the PAT (table ID=0x00), these tables are to be transferred in the order of PAT and PMT (ST213, ST214, ST215). After all the SI data are transferred, a counter that measures the reproduction timing in the time measurement unit of a player is set to be APATx (ST209), and reproduction starts from an MPEG-TS packet having time information APATx (ST210).

FIG. 19 shows an example of times required to transfer the management information and object data.

MPEG-TS packets that contain SI recorded in the management information are transferred to have a transfer time difference:

t0≧188×8 bits/k Mbps (sec)

k: maximum transfer rate

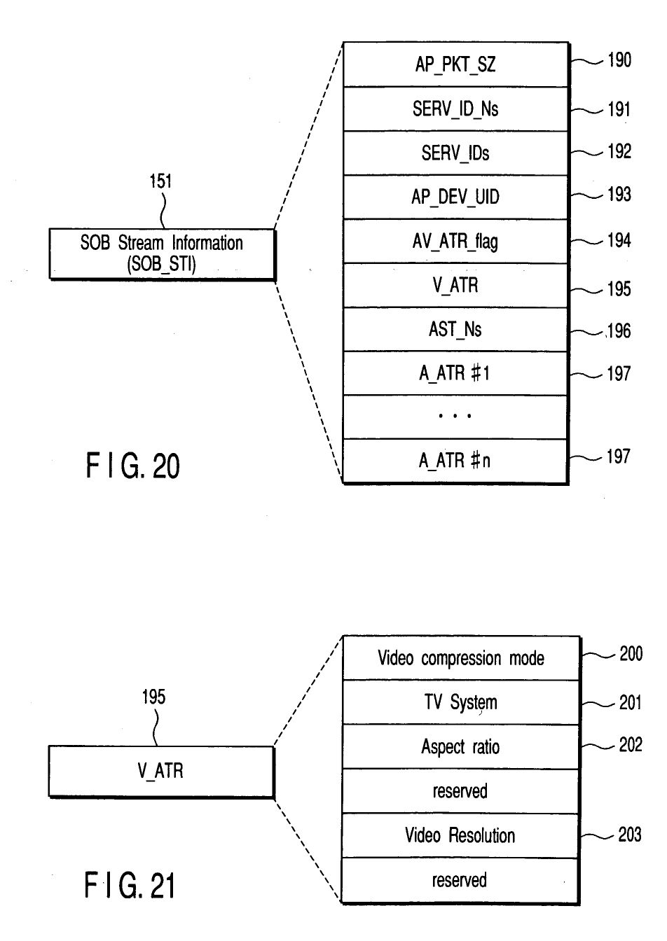

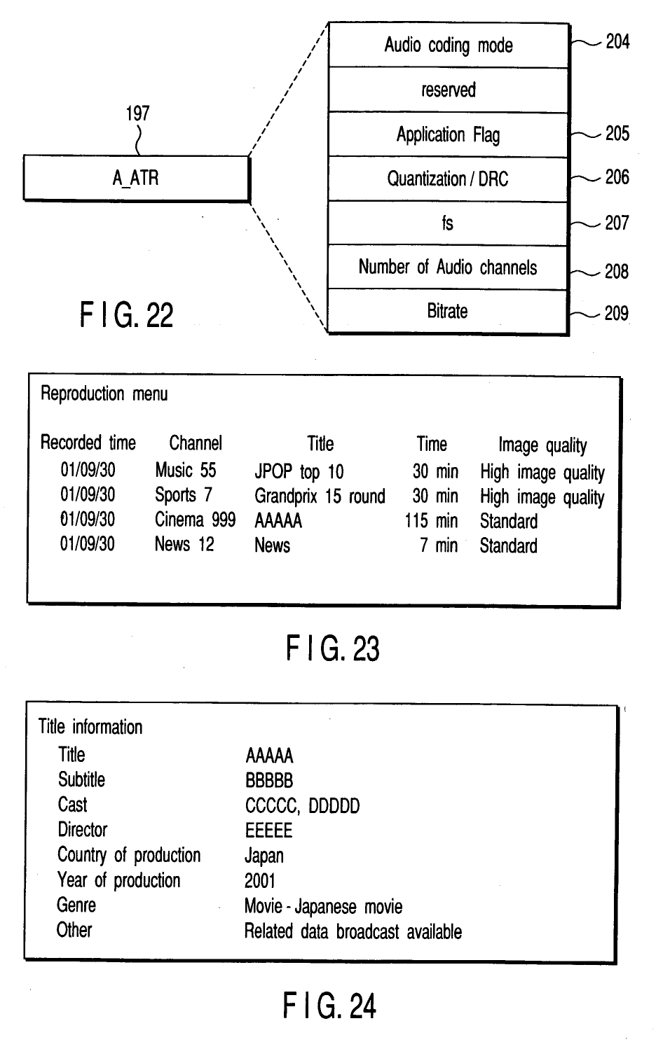

FIG. 20 shows an example of the structure of the SOB stream information (SOB_STI) 151 in the management information of the information storage medium. FIG. 21 shows an example of the data structure of V-ATR. FIG. 22 shows an example of the data structure of A-ATR.

Each SOB_STI 151 that records attribute information of the recorded object consists of AP_PKT_SZ 190 (0xBC in case of MPEG-TS) indicating the packet size, SERV_ID_Ns 191 indicating the number of service IDs, SERV_IDs 192 indicating one or more service IDs, AP_DEV_UID 193 indicating the ID of an apparatus such as the STB or the like, AV_ATR_flag 194 indicating the presence/absence of V_ATR data 195 and A_ATR data 197, V_ATR data 195 indicating a video attribute, AST_Ns 196 indicating the number of audio streams, and A_ATR data 197 indicating an audio attribute. Especially, if the AV_ATR_flag 194 is 0b, it indicates that neither the V_ATR data 195 nor A_ATR data 197 are present; if the AV_ATR_flag 194 is 1b, it indicates that one or more V_ATR data 195 or A_ATR data 197 are present. The number of A_ATR data 197 corresponds to that of audio streams, i.e., the AST_Ns 196.

The V_ATR data 195 indicating a video attribute includes video compression mode 200 that indicates the video encoding attribute, TV system 201 indicating the TV system, aspect ratio 202 indicating the aspect ratio of the screen, and video resolution 203 indicating the resolution of the screen. An example of the relationship between these parameters and their values is as follows.

<Example of Attribute Information of V_ATR>

Video compression mode;

01b: Complied with MPEG-2

TV system;

10b: BS/broadband CS broadcast

Aspect ratio;

00b: 4:3

01b: 16:9 without pan vector

10b: 16:9 with pan vector

11b: more than 16:9

Video Resolution;

000b: 480i/525i

001b: 480p/525p

010b: 1080i/1125i

011b: 720p/750p

Especially, the video resolution 203 indicating the resolution contains information indicating an interlaced or progressive scan in addition to the number of pixels in the horizontal direction. The interlaced scan displays an image by skipping every other scan line. Two scans are made, and odd- and even-fields are alternately scanned to form one frame. The progressive scan displays a full image without skipping any scan lines. That is, a video is scanned in turn from the above without skipping scan lines, unlike in the interlaced scan.

The A_ATR data 197 indicating an audio attribute consists of audio coding mode 204 indicating the audio encoding attribute, application flag 205 indicating whether the number of audio channels changes in a program, quantization/DRC 206 indicating information of quantization and dynamic range control, fs 207 indicating the sampling frequency, number of audio channels 208 indicating the number of audio channels, and bitrate 209 indicating the bitrate. An example of the relationship between these parameters and their values is as follows.

<Example of Attribute Information of A_ATR>

Audio coding mode;

000b: Dolby AC-3

010b: MPEG-1 or MPEG-2 without extension bitstream

011b: MPEG-2 with extension bistream

100b: Linear PCM audio

Application Flag;

00b: Number of Audio channels changes

01b: Number of Audio channels does not change

Quantization/DRC;

00b: Without dynamic range control data (Audio coding mode=010b or 011b) 16 bit (Audio coding mode=100b)

01b: With dynamic range control data (Audio coding mode=010b or 011b)

11b: (Audio coding mode=000b) fs;

00b: 48 kHz

01b: 44.1 kHz

A case will be exemplified below wherein the recorder/player generates V_ATR data 195, AST_Ns 196, and A_ATR data 197 using information of service information (SI) 189 generated by searching for SI data contained in the recorded object data (SIT or the like) or SI data contained in object data.

Since SI data are inevitably contained in the recorded object data, and required SI data on object data are extracted in some cases as service information (SI) 189 in the application private data manager (APDT_MG) 145 in the management information in the sequence shown in FIG. 15, the V_ATR data 195, AST_Ns 196, and A_ATR data 197 can be generated using either information.

For example, a case will be examined wherein SIT data shown in FIG. 11 are recorded. Based on the network identifier descriptor, video component descriptor (descriptor_tag=0x50, stream_content=0x01), and audio component descriptor (descriptor_tag=0x50, stream_content=0x02) in the SIT, the following values can be set as V_ATR data 195.

Video compression mode;

01b: Complied with MPEG-2

TV System;

10b: BS/broadband CS broadcast

Aspect ratio;

10b: 16:9 with pan vector

Video Resolution;

001b: 480p/525p

Also, the AST_Ns 196 can be set to be 0001b, and the following values can be set as A_ATR data 197.

Audio coding mode;

011b: MPEG-2 with extension bitstream

Application Flag;

01: Number of Audio channels does not change

Number of Audio channels;

0001b: 2ch (stereo)

By sending the information of the V_ATR 195 and A_ATR 197, which are set in this way, to the MPEG decoder and an audio decoder in the STB at the beginning of reproduction, appropriate values can be set in advance in respective decoder ICs.

FIG. 26 shows an example of the flow upon generating the video attribute data V_ATR 195.

It is checked whether service information (SI) 189 in the application private data manager (APDT_MG) in the management information contains an SIT (by searching for Table ID=0x7F) (ST301), and the found SIT is read (ST302). Or an object is searched for an SIT MPEG-TS packet, and the found SIT is read (ST306). For example, if the SIT contains a network identifier descriptor (descriptor_tag=0xC2) (ST303, YES), that descriptor reveals a digital broadcast complying with DVB or ARIB, and the video compression mode 200=01b: Compliant with MPEG-2, and the TV system 201=10b: BS/broadband CS broadcast are set (ST307). If the video component descriptor (descriptor_tag=0x50, stream_content=0x01) is contained (ST304, YES), the horizontal resolution, aspect ratio, the presence/absence of a pan vector, and interlaced or progressive scan can be determined from this information. Based on this information, values are set in the aspect ratio 202 and video resolution 203 (ST308).

Finally, the V_ATR data 195 are recorded, and the AV_ATR_flag 194=1b is set (ST305).

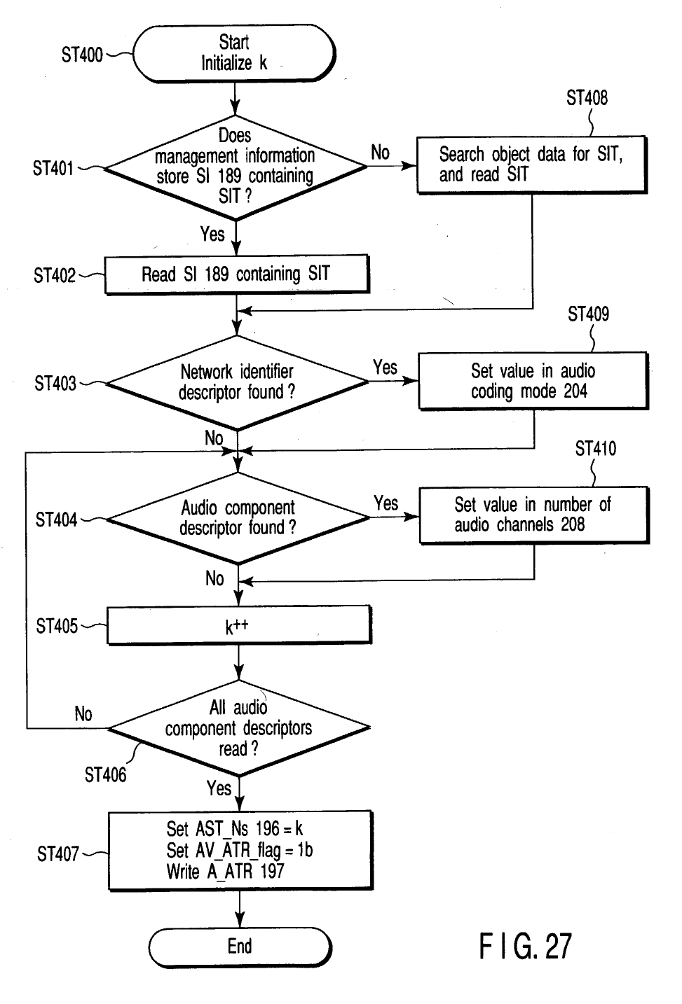

FIG. 27 shows an example of the flow upon generating the audio attribute data A_ATR 197.

It is checked whether service information (SI) 189 in the application private data manager (APDT_MG) in the management information contains an SIT (by searching for Table ID=0x7F) (ST401), and the found SIT is read (ST402). Or an object is searched for an SIT MPEG-TS packet, and the found SIT is read (ST408). For example, if the SIT contains a network identifier descriptor (descriptor_tag=0xC2) (ST403, YES), that descriptor reveals a digital broadcast complying with DVB or ARIB, and a value is set in the audio coding mode 204=011b: MPEG-2 ACC (ST409). Then, an audio component descriptor (descriptor_tag=0x50, stream_content=0x02) is searched for (ST404). At this time, if there are a plurality of streams (a plurality of components), the number of streams is set in the AST_Ns, and A_ATR fields 197 corresponding to the AST_Ns are assured. Audio component descriptors of the respective streams are read, and a value is set in the number of audio channels 208 based on the read information (ST410). After all the audio component descriptors are read (ST406, YES), the A_ATR data 197 are recorded, and the AV ATR_flag 194 is set to be 1 (ST407).

Also, SI data (especially, SIT data) can be used to search for contents recorded on the information storage medium. At this time, if the SI data are present only in normally recorded objects, the recorder/player must search for SITs in objects in correspondence with the number of programs (the number of SOBs), thus requiring a very long time. At this time, it is very effective to record required SI data (especially, SIT data) in the objects in the service information (SI) 189 in the application private data manager (APDT_MG) 145 in the management information, as shown in FIG. 15.

FIG. 23 shows an example of the configuration of a reproduction menu using the SIT data. Since the rectangle event descriptor in the SIT contains title information, the partial transport stream time descriptor (descriptor_tag=0x3C) contains program time information, and the component descriptor (descriptor_tag=0x50) contains image quality information, the title information extractor extracts these data from the SIT recorded in the service information (SI) 189 in the management information and the extracted data can be used as a reproduction menu. Especially, it is preferable for the user to replace words “HDTV” (High Definition TV) using a resolution of 1080i (1125i) or 720p (750p), and “SDTV” (Standard Definition TV) using a resolution of 480i (525i) or 480p (525p) by plain words such as “high quality” or “hi-vision”, and “standard”.

FIG. 24 shows an example of a program information menu using the SIT. Since the rectangle event descriptor (descriptor_tag=0x4D) in the SIT contains title information, the extended event descriptor (descriptor_tag=0x4E) contains detailed title information, the content descriptor (descriptor_tag=0x50) contains the genre of a program, and the linkage descriptor (descriptor_tag=0x4A) contains the presence/absence of linked data broadcast or the like, these data can be used as a program information menu.

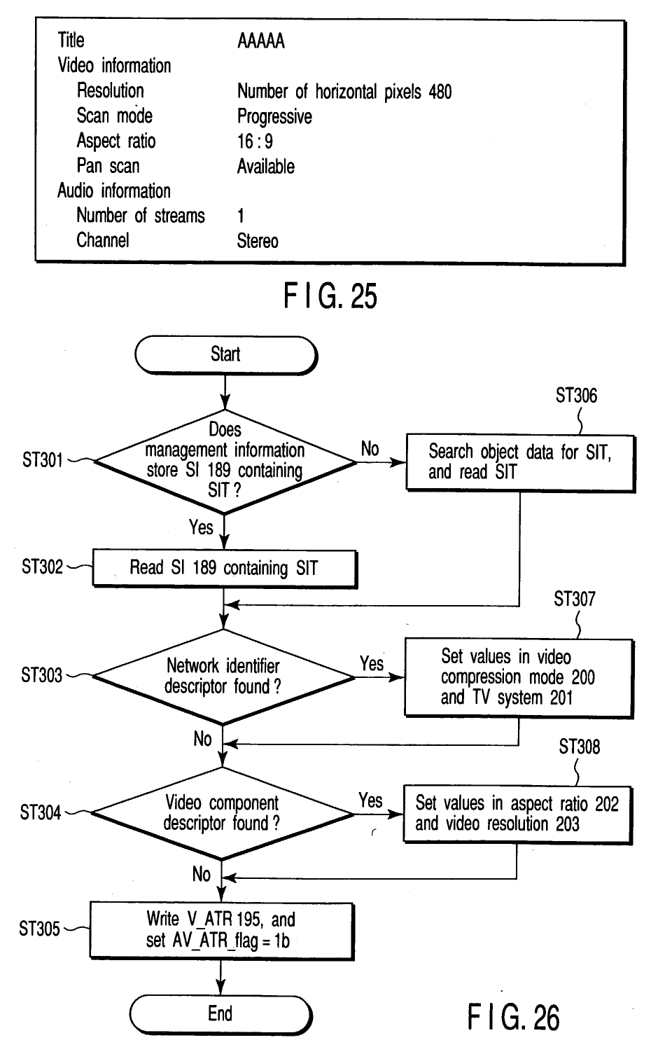

FIG. 25 shows an example of the configuration of a video/audio information menu using the SIT. Since the rectangle event descriptor (descriptor_tag=0x4D) in the SIT contains title information, and the component descriptor (descriptor_tag=0x50) contains the video resolution, video scan mode, video aspect ratio, video pan scan, number of audio streams, and number of audio channels, these data can be used as video/audio attribute information menu.

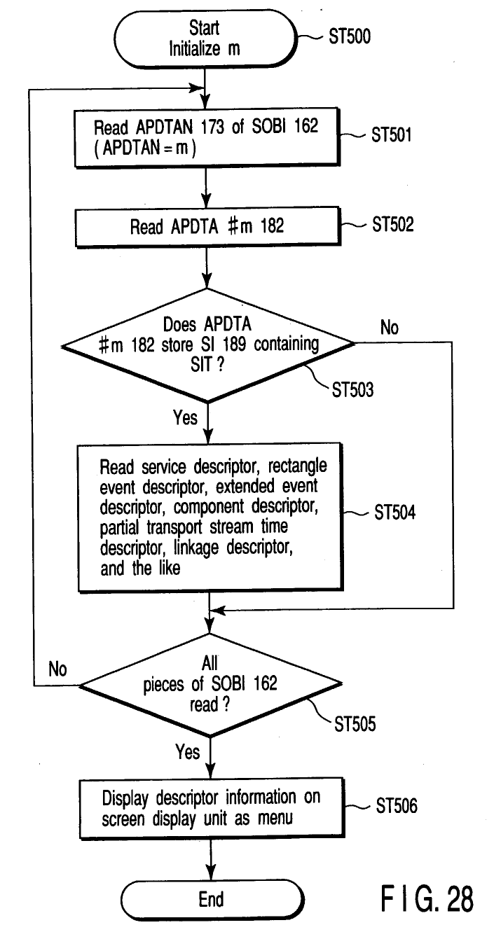

FIG. 28 shows an example of the flow upon displaying a menu.

SOBI 162 that records one object information in the management information is read (ST501). The APDTAN 173 in this SOBI 162 records the number of the APDTA 182 to be referred to (ST502). The corresponding APDTA 182 is searched for SI 189 that contains an SIT (Table ID=0x7F) (ST503). If an SIT is contained, various kinds of information in the SIT such as the service descriptor (descriptor_tag=0x48), linkage descriptor (descriptor_tag=0x4A), rectangle event descriptor (descriptor_tag=0x4D), extended event descriptor (descriptor_tag=0x4E), component descriptor (descriptor_tag=0x50), partial transport stream time descriptor (descriptor_tag=0x3C), and the like are read (ST504). In this manner, the SIT data of respective APDTAs 182 corresponding to all pieces of SOBI 162 are read (ST505).

Finally, the screen display unit of the recorder/player displays these pieces of descriptor information as a menu, and outputs the menu to the TV (ST506).

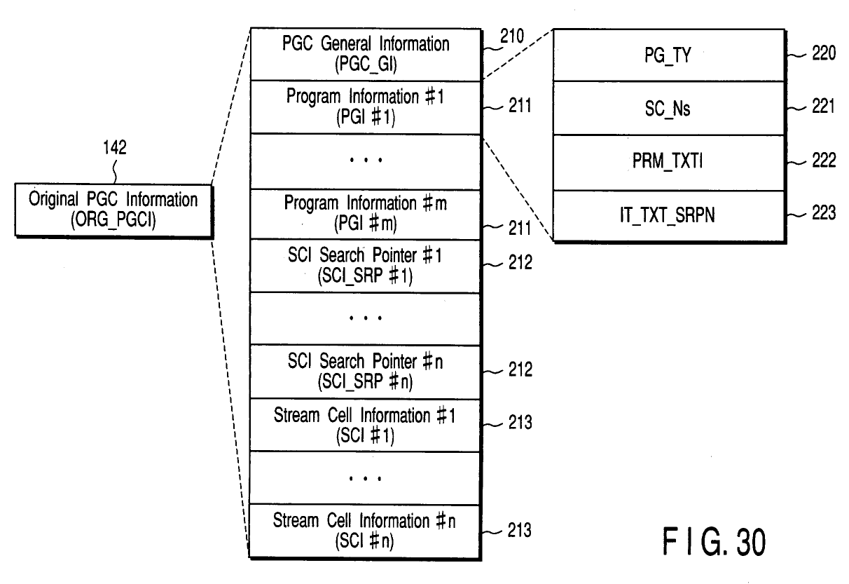

FIG. 30 shows an example of the structure of original PGC information (ORG_PGCI) 142 in the management information of the information storage medium.

The ORG_PGCI 142 that records program reproduction information of the recorded object consists of PGC general information (PGC_GI) 210 that records general information of the ORG_PGCI 142, program information (PGI) 211 that records information of a program, SCI search pointers (SCI_SRP) 212 each indicating the storage location of stream cell information (SCI) 213, and a plurality of pieces of stream cell information (SCI) 213 each indicating cell information. Also, the PGI 211 consists of PG_TY 220 indicating attributes of the program, SC_Ns 221 indicating the number of cells in the program, PRM_TXTI 222 indicating text information corresponding to the program, and IT_TXT_SRPN 223 indicating the storage location of IT_TXT corresponding to the program. Especially, the PRM_TXTI 222 records text information of the program, and is used to display information of programs recorded on a disk as a menu.

Conventionally, the user himself or herself must record such text information via a remote controller, or an input device such as a keyboard. The recorder/player of the present invention extracts information such as the title of a program and the like from the SIT recorded in each object, and records the extracted information in the PRM_TXTI. In this way, the information of programs recorded on a disk can be easily displayed as a menu without any load on the user.

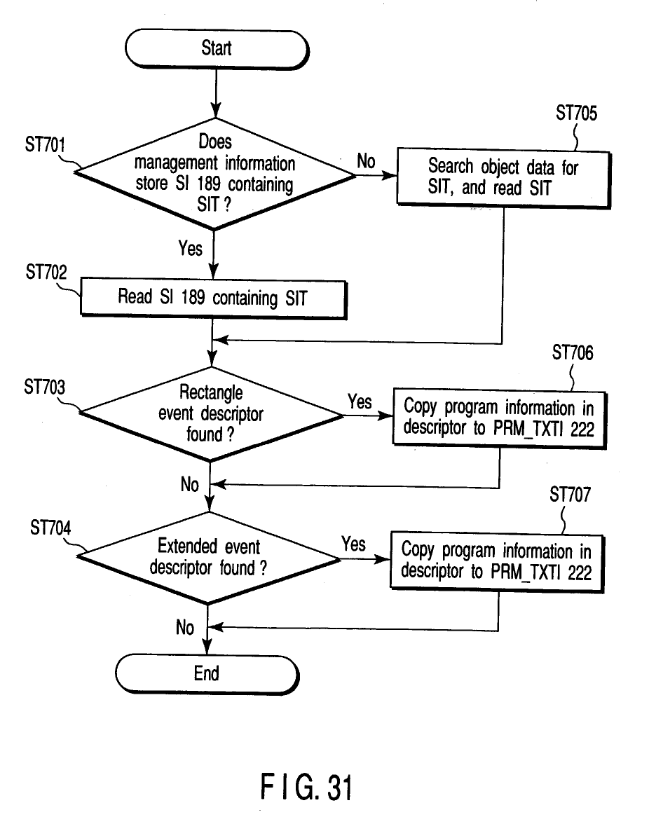

FIG. 31 shows an example of the flow upon generating the PRM_TXTI 222.

It is checked if service information (SI) 189 in the application private data manager (APDT_MG) in the management information contains an SIT (by searching for Table ID=0x7F) (ST701), and the found SIT is read (ST702). Or an object is searched for an SIT MPEG-TS packet, and the found SIT is read (ST705). For example, if the SIT contains the rectangle event descriptor (descriptor_tag=0x4D) or extended event descriptor (descriptor_tag=0x4E) (ST703 or ST704, YES), that descriptor describes program information such as the title of a recorded program or the like, and the PRM_TXTI 222 is set based on this information (ST706 or ST707).

As described above, the information storage medium of the present invention is a medium that records digital broadcast signals complying with MPEG-TS. This medium includes a management area for recording management information, and a data area for recording program contents data. The program contents data includes a plurality of object data. Each object data includes a plurality of data units. Each data unit includes a plurality of MPEG-TS packets. The management information includes service information (SI) of the program contents data. The service information (SI) includes a first table (PAT), second table (PMT), and third table (SIT). Also, the management area includes changed service information, and changed location information of the service information upon a change in service information. Since the management information recorded on the information storage medium includes the service information, the service information alone can be easily used as a menu or the like. Also, the service information can be transferred prior to a stream to be reproduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information storage medium comprising:
a management area for recording management information; and
a data area for recording program contents data,
wherein the program contents data recorded in the data area contains a plurality of object data,
each object data contains a plurality of data units,
each data unit contains a plurality of packets, and
the management information recorded in the management area contains program stream information of the program contents data.

2. A medium according to claim 1, wherein the program stream information contains at least one of a first table that contains abstract information of the program stream information, a second table that contains identification information of the packets for the first table, and a third table that contains identification information of the packets for the second table.

3. A medium according to claim 1, wherein the management information contains changed program stream information and changed time information of the program stream information upon a change in program stream information.

4. A medium according to claim 1, wherein the management information contains information indicating a progressive or interlaced scan as information associated with a scan mode of the program contents data recorded in the data area.

5. An information recording apparatus for recording information on an information storage medium including a management area and data area, comprising:
a first recording unit recording management information in the management area, and
a second recording unit recording program contents data in the data area,
wherein the program contents data recorded in the data area contains a plurality of object data,
each object data contains a plurality of data units,
each data unit contains a plurality of packets, and
the management information recorded in the management area contains program stream information of the program contents data.

6. An apparatus according to claim 5, wherein the program stream information contains at least one of a first table that contains abstract information of the program stream information, a second table that contains identification information of the packets, and a third table that contains identification information of the packets as well as the second table.

7. An apparatus according to claim 5, wherein the management information contains changed program stream information and changed location information of the program stream information upon a change in program stream information.

8. An apparatus according to claim 5, wherein the management information contains information that indicates reproduction order of the object data, and video attribute information of the object data, and
the information recording apparatus further comprises an attribute information generator generating the video attribute information of the object data on the basis of the program stream information.

9. An apparatus according to claim 5, wherein the management information contains information that indicates reproduction order of the object data, and audio attribute information of the object data, and
the information recording apparatus further comprises an attribute information generator generating the audio attribute information of the object data on the basis of the program stream information.

10. An apparatus according to claim 5, wherein the program stream information contains a first table that contains abstract information of the program stream information,
the management information contains information indicating reproduction order of the object data, and
the information recording apparatus further comprises:
a title information extractor extracting title information from the first table included in the program stream information; and
a display unit displaying the title information extracted by the title information extractor.

11. An information reproduction apparatus for reproducing information from an information storage medium including a management area and data area, comprising:
a first reproduction unit reproducing management information from the management area; and
a second reproduction unit reproducing program contents data from the data area,
wherein the program contents data recorded in the data area contains a plurality of object data,
each object data contains a plurality of data units,
each data unit contains a plurality of packets, and
the management information recorded in the management area contains program stream information of the program contents data.

12. An apparatus according to claim 11, wherein the program stream information contains at least one of a first table that contains abstract information of the program stream information, a second table that contains identification information of the packets for the first table, and a third table that contains identification information of the packets for the second table.

13. An apparatus according to claim 11, wherein the management information contains changed program stream information and changed location information of the program stream information upon a change in program stream information.

14. An apparatus according to claim 11, wherein the management information contains information that indicates reproduction order of the object data, and
the information reproduction apparatus further comprises:
a detector detecting if a reproduction start point starts from a third table; and
a data transfer unit transmitting, when the detector detects that the reproduction start point does not start from the third table, first, second, and third tables included in the program stream information, and then to start transfer of the object data.

15. An apparatus according to claim 11, wherein the management information contains information that indicates reproduction order of the object data, and
the information reproduction apparatus further comprises:
a title information extractor extracting title information from a first table included in the program stream information; and
a display unit displaying the title information extracted by the title information extractor.
